(19) United States
(12) Patent Application Publication
(10) Pub. No.: US 2006/0120225 A1
(43) Pub. Date: Jun. 8, 2006

(54) Apparatus and method for synchronizing audio with video

(75) Inventor: Woo Young Choi, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/295,209

(22) Filed: Dec. 5, 2005

(30) Foreign Application Priority Data
Dec. 6, 2004 (KR) 10-2004-0101886

(51) Int. Cl. G11B 21/08

(52) U.S. Cl. 369/30.09

(57) ABSTRACT

An apparatus for synchronizing audio with video is provided. The apparatus includes a storage unit, a decoder, an audio output unit, a dB level setting unit, and a synchronizer. The storage unit stores a music file containing audio data and image data therein, and the decoder decodes the audio data when the music file is selected. The audio output unit processes the audio data decoded by the decoder so that the audio data may be outputted, and the dB level setting unit sets the dB level of the decoded audio data. The synchronizer selects an image according to the dB level and allows the image to be outputted in synchronization with the audio data.

Pursuant to 35 U.S.C. § 119(a), this application claims the benefit of earlier filing date and right of priority to Korean Patent Application No. 10-2004-0101886, filed on Dec. 6, 2004, the content of which is hereby incorporated by reference herein in its entirety.

### BACKGROUND OF THE INVENTION

1. Field of the Invention

The present invention relates to apparatus and method for synchronizing audio with video.

2. Description of the Related Art

Portable terminals such as a cellular phone, a personal digital assistant (PDA), and a smart phone, provide a variety of functions including an e-mail function, a game function, a photographing function, a voice recording function, a music playing function, and a still image/moving image reproduction function, as well as a basic communication function.

Particularly, a PDA providing a music playing function of an MP3 (MPEG-1 audio layer 3) player and a function of displaying a predetermined image in accordance with playing of music, is being developed.

A technology for displaying a predetermined image in accordance with the playing of music uses a technology of extracting the characteristics of the music and displaying images that correspond to the characteristics of the music in synchronization with the playing of the music.

To extract the characteristics of the music, the related art has mainly used the waveform of the music through a technology in which a digital audio apparatus synchronizes pieces of music with a plurality of images using a maximum wave pitch per frame.

FIG. 1 is a graph illustrating waveforms A and B representing sound pressures according to a time in the related art, and FIG. 2 is a graph illustrating sound pressures C, D, E, and F for respective frequencies in the related art.

As illustrated in FIGS. 1 and 2, the related art depends on the waveform according to the sound pressure. The waveforms illustrated in FIG. 1 represent the sound pressures A and B outputted through a left speaker and a right speaker, respectively. Also, the waveforms illustrated in FIG. 2 represent sound pressures C, C, E, and F for respective frequencies using only four samples. Such level values are simple and limited references and thus insufficient in expressing the characteristics of music using images.

When music is synchronized with a plurality of images using the wave pitch values, speed with which the images move is too fast and the wave pitch values are varied too much for respective frames of a music file, so that the synchronization is not realized naturally.

Therefore, an apparatus for synchronizing audio with video, capable of selecting and displaying images that correspond to the various characteristics of music and thus naturally synchronizing the images with the music being played, is required.

Also, an apparatus for synchronizing audio with video, capable of minimizing load applied to a portable terminal and minimizing a time difference between playing of music and reproducing of an image by excluding complicated operations, is highly required.

### SUMMARY OF THE INVENTION

Accordingly, the present invention is directed to apparatus and method for synchronizing audio with video that substantially obviate one or more problems due to limitations and disadvantages of the related art.

An object of the present invention is to provide apparatus and method for synchronizing audio with video, capable of allowing audio data to be outputted in synchronization with image data by performing FFT on audio data and selecting/displaying image data according to a dB level in a low frequency band.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for synchronizing audio with video, the apparatus including: a storage unit for storing a music file containing audio data and image data; a decoder for decoding the audio data when the music file is selected; an audio output unit for processing the audio data decoded by the decoder so that the audio data is outputted; a dB level setting unit for setting the dB level of the decoded audio data; and a synchronizer for selecting image data according to the dB level and allowing the image data to be outputted in synchronization with the audio data.

In another aspect of the present invention, there is provided an apparatus for synchronizing audio with video, the apparatus including: a storage unit for storing a music file and image data; a decoder for decoding audio data of the music file when the music file is selected; an audio output unit for processing the audio data decoded by the decoder so that the audio data is outputted; an dB level setting unit for setting the dB level of the decoded audio data; and a synchronizer for selecting the image data stored in the storage unit according to the dB level and allowing the image data to be outputted in synchronization with the audio data.

In a further another aspect of the present invention, there is provided a method for synchronizing audio with video, the method including: accessing selected audio data for each frame to decode the audio data into pulse code modulation (PCM) data and outputting the same; converting the PCM data into data in a frequency region; selecting image data according to the dB level of the PCM data; and displaying the image data in synchronization with the audio data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a graph illustrating general waveforms A and B representing sound pressures according to a time in the related art;

FIG. 2 is a graph illustrating sound pressures for respective frequencies in the related art;

FIG. 3 is a view explaining an apparatus for synchronizing audio with video according to an embodiment of the present invention;

FIG. 4 is a schematic data block diagram illustrating the structure of a music file in which image data is inserted in an apparatus for synchronizing audio with video according to an embodiment of the present invention;

FIG. 5 is a graph illustrating DB levels set through FFT by a DB level setting unit of an apparatus for synchronizing audio with video according to an embodiment of the present invention;

FIG. 6 is a view exemplarily illustrating a series of image data that correspond to the dB level of audio data in an apparatus for synchronizing audio with video according to an embodiment of the present invention; and

FIG. 7 is a flowchart of a method for synchronizing audio with video according to an embodiment of the present invention.

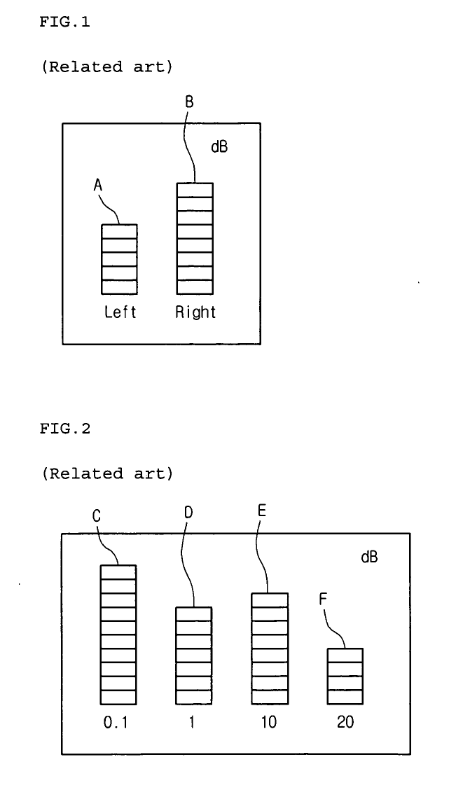

### DETAILED DESCRIPTION OF THE INVENTION

Reference will now be made in detail to the preferred embodiments of the present invention, examples of which are illustrated in the accompanying drawings.

Apparatus and method for synchronizing audio with video according to the present invention may be applied to a variety of apparatus. For convenience, descriptions are made for embodiments applied to portable terminals such as a cellular phone, a smart phone, and a personal digital assistant (PDA).

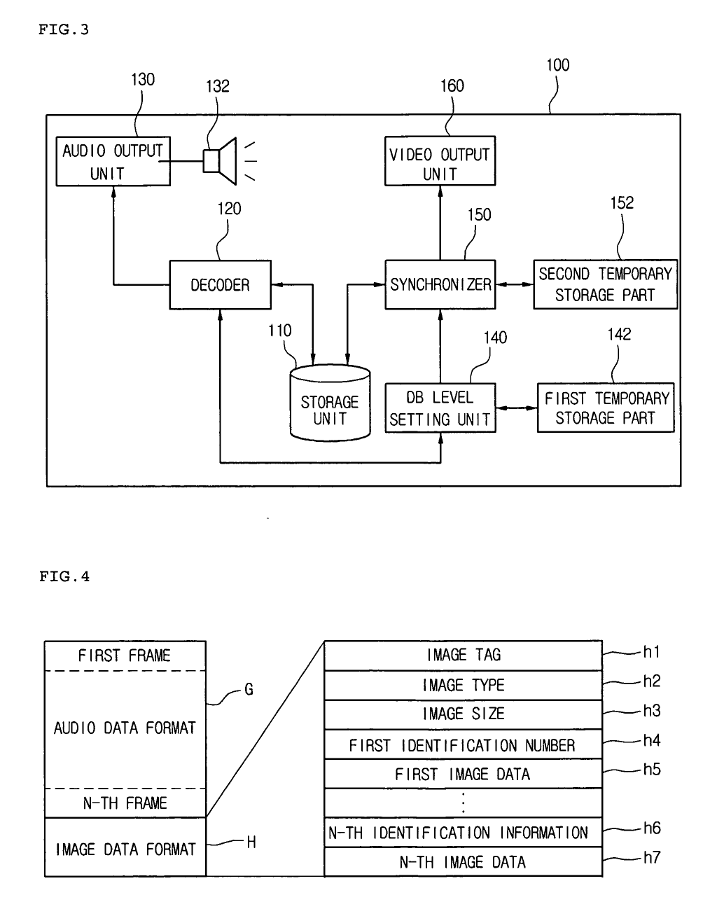

FIG. 3 is a schematic block diagram partially illustrating the construction of a portable terminal 100 having an apparatus for synchronizing audio with video according to an embodiment of the present invention.

Referring to FIG. 3, the portable terminal 100 includes a storage unit 110, a video output unit 160, a decoder 120, an audio output unit 130, a speaker 132, a dB level setting unit 140, and a synchronizer 150.

The video output unit 160 includes a liquid crystal display (LCD) panel to control a display operation. When a series of image data is transmitted from the synchronizer 150 in accordance with a play of a music file, the video output unit 160 displays the transmitted image data in real-time.

The storage unit 110 stores a music file. The music file is stored in a file format such as an MP3 and contains a series of image data that correspond to the dB level of audio data.

The music file has a frame-based structure and each frame is marked by a marker. The image data may be inserted right after a last frame of audio data.

FIG. 4 is a schematic data block diagram illustrating the structure of a music file in which image data is inserted in an apparatus for synchronizing audio with video according to an embodiment of the present invention.

Referring to FIG. 4, the music file according to an embodiment of the present invention includes: an audio data format G and an image data format H separated by each frame. The image data format H includes an image tag h1, an image format h2, an image size h3, and image identification numbers h4 and h6, and image data h5 and h7.

For example, after the image data illustrated in FIG. 4 is inserted into the music file through an application on an external device such as a personal computer (PC), the music file may be stored in the storage unit 110.

The audio data format G is separated from the image data format H by the image tag h1. Also, the image type h2 coincides with a decoding type of the decoder 120, and the image size h3 coincides with a screen format provided by the video output unit 160.

Here, the image identification numbers h4 and h6 are identifiers that correspond to the dB level of the audio data. The synchronizer 150 uses the image identification numbers in selecting the image data.

According to another embodiment of the present invention, the image data may be stored in the storage unit 110 separately from the audio data.

That is, the image data may not exist in the form inserted into the music file, but may be stored in the storage unit 110 independently of the music file and selectively used according to the dB level of the audio data.

In that case, the image data includes the image identification numbers and is selected according to the dB level of the audio data.

When the music file is selected, the decoder 120 accesses the audio data from the storage unit 110 for each frame, and decodes the audio data to convert the same into PCM data. Pulse code modulation (PCM) quantizes the frequency waveform of a music signal to express an amplitude value of the frequency waveform using a binary number. The PCM is used for recording and playing audio data with a sampling rate 44.1 KHz and a 16-bit quantization type.

The audio output part 130 receives PCM data from the decoder 120 and converts the received PCM data into analog signals and output the same through a speaker 132. Instead of the speaker 132, an audio output terminal may be provided. The audio output terminal may be connected with an earphone or a headset.

The dB level setting unit 140 includes the first temporary storage part 142, which may be used for a buffer.

The dB level setting unit 140 receives the PCM data from the decoder 120, stores the PCM data in the first temporary storage part 142 for each frame, and performs fast-Fourier-transform (FFT) on the PCM data to set a dB level for each frequency.

The FFT is an algorithm for converting a continuous time function into a continuous frequency function. Since the FFT may reduce a complex number multiplication calculation amount of (sampling number)² to sampling number/2×log₂ (sampling number), the calculation speed is much fast.

At this point, the dB level setting unit 140 regularly counts the PCM data and performs the FFT on the PCM data when the number of the PCM data is greater than a predetermined size for the FFT.

Here, the size for the FFT should be designated for natural synchronization of the audio data with the image data.

For example, assuming that 10 frame images are displayed per second using a music file recorded with a sampling rate 44.1 KHz so that a series of images may naturally move in accordance with the playing speed of the music file, the FFT of 4096 samples may be used.

The dB level setting unit 140 extracts the low-frequency component of the audio data and sets a dB level for each frequency using the FFT.

For example, the audio frequency band is a band of 20-20 KHz. According to the present invention, the dB level is set for the frequency band of 20-500 Hz.

The reason the dB level is set for the low-frequency band is that setting the dB level for base sounds (e.g., sounds that correspond to the range of a drum or a bass) constituting the frame of music may most naturally match with the images when the music is synchronized with the images.

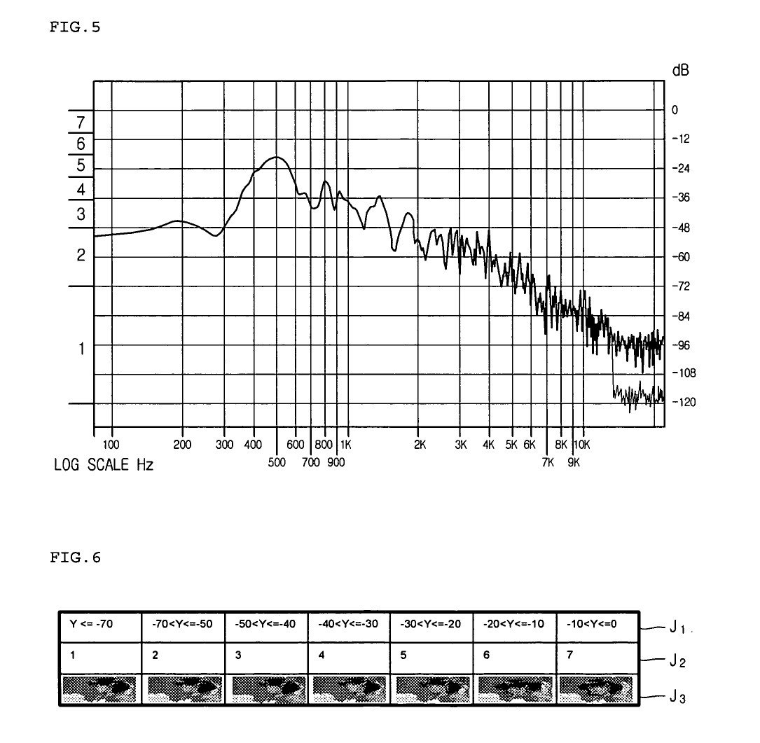

FIG. 5 is a graph illustrating DB levels set through FFT by a DB level setting unit of an apparatus for synchronizing audio with video according to an embodiment of the present invention. In FIG. 5, an y axis has a unit of dB and an x axis has a unit of frequency (Hz) in a log scale.

FIG. 5 illustrates a dB level for the frequency range of 100 Hz-10 KHz. That is, an y axis includes −120 dB to 0 dB, and the dB level setting unit 140 sets “−120 dB˜−70 dB” for the first level, “−70 dB˜−50 dB” for the second level, “−50 dB˜−40 dB” for the third level, “−40 dB˜−30 dB” for the fourth level, 30 dB˜−20 dB” for the fifth level, “−20 dB˜−10 dB” for the sixth level, and “−10 dB˜0 dB” for the seventh level. These dB levels correspond to the identification numbers (h4 and h6 of FIG. 4) given to the image data.

As described above, the present invention selects image data according to the dB level of the frequency band of 20-500 Hz. For an embodiment, the image data can be selected using the dB level of a frequency 100 Hz.

When music is played for each frame by passing through the above processes and a series of images is displayed, the dB level setting unit 140 initializes the first temporary storage part 142 and the counting of the PCM data, and repeats operations of storing, counting, FFT, and setting of a dB level with respect to PCM data that follows subsequently, until the playing of the music is ended.

The synchronizer 150 includes the second temporary storage part for storing image data.

When the music file is selected and converting/outputting (playing) of the music starts by the audio output unit 130 The synchronizer 150, the synchronizer 150 extracts image data inserted into the music file and stores the second temporary storage part 152.

Subsequently, the synchronizer 150 receives dB level information of a relevant PCM data frame form the dB level setting unit 140 and recognizes an identification number that corresponds to the dB level of the audio data to select an image data.

When the image data is selected, the synchronizer 150 transmits the image data to the video output unit 160 so that the image data may be displayed.

As the dB level setting unit 140 repeats a function thereof until the playing of the music is ended, the synchronizer 150 also repeats a function of synchronizing the playing of the image with the playing of the audio.

FIG. 6 is a view exemplarily illustrating a series of image data that correspond to the dB level of audio data in an apparatus for synchronizing audio with video according to an embodiment of the present invention.

Referring to FIG. 6, a dB level J2 is set according to a dB value J1, and a series of image data J3 that corresponds to the dB level J2 is illustrated. For this correspondence relationship, identification numbers (h4 and h6 of FIG. 4) are given to image data. Referring to FIG. 6, the identification numbers are matched with the same numbers as those of the dB levels J2.

A method for synchronizing audio with video according to an embodiment of the present invention will be described with reference to the accompany drawings.

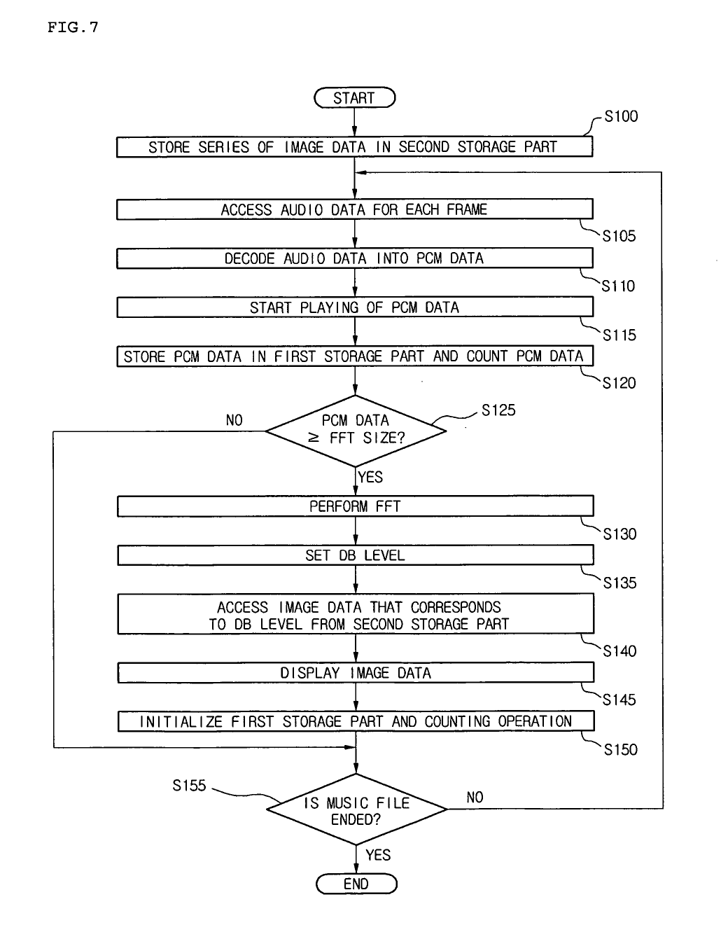

FIG. 7 is a flowchart of a method for synchronizing audio with video according to an embodiment of the present invention.

Referring to FIG. 7, when a music file is selected, a synchronizer 150 extracts a series of image data incorporated into the music file and stored the extracted image data in the second temporary storage part 152 (S100).

A decoder 120 accesses audio data for each frame from the music file (S105) and decodes the audio data into PCM data (s110).

Subsequently, an audio output unit 130 amplifies the coded audio data to start playing of the audio data through a speaker 132 (S115).

When the playing of music starts, a dB level setting unit 140 receives the PCM data for each frame from the decoder 120, stores the PCM data in the first temporary storage part 142, and counts the PCM data (S120).

When the number of the PCM data is greater than the size for FFT as a result of counting of the PCM data (S125), the dB level setting unit 140 performs FFT on the PCM data to convert the PCM data into data in a frequency region (S130).

The dB level setting unit 140 sets a dB level (S135) and transmits the dB level to a synchronizer 150. The synchronizer 150 accesses image data that corresponds to the dB level from the second temporary storage part 152, and transmits the image data to the video output unit 160 (S140).

Therefore, the image data is displayed through the video output unit 160 in synchronization with the audio data outputted from the audio output unit 130 (S145).

When the audio data for each frame and a series of image data that correspond thereto are played, the dB level setting unit 140 initializes the first temporary storage part 142 and the counting of the PCM data (S150), receives next audio data for each frame from the decoder 120, and performs operations of storing, counting, FFT, and setting of a dB level with respect to the received audio data. Subsequently, the synchronizer 150 performs synchronized playing of the image data according to the dB level and the dB level setting unit 140 repeats count initialization (S105 to S150).

Finally, when a user ends the playing of the music file or the entire music file is played and the PCM data is not counted no more (S155), the apparatus for synchronizing audio with video ends an operation thereof.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for synchronizing audio with video, the apparatus comprising:
a storage unit for storing a music file containing audio data and image data;
a decoder for decoding the audio data when the music file is selected;
an audio output unit for processing the audio data decoded by the decoder so that the audio data is outputted;
a dB level setting unit for setting the dB level of the decoded audio data; and
a synchronizer for selecting image data according to the dB level and allowing the image data to be outputted in synchronization with the audio data.

2. The apparatus according to claim 1, wherein the image data is inserted into a last frame of the audio data.

3. The apparatus according to claim 1, wherein the image data comprises an image tag for separating the audio data from the image data, and an image identifier for indicating the image data selected according to the dB level of the audio data.

4. The apparatus according to claim 1, wherein the decoder accesses and decodes the audio data for each frame to convert the audio data into PCM (pulse code modulation) data.

5. The apparatus according to claim 4, wherein the audio output unit converts the PCM data into analog signals.

6. The apparatus according to claim 5, wherein the dB level setting unit sets the dB level by performing FFT (fast Fourier transform) on the PCM data.

7. The apparatus according to claim 6, wherein the dB level setting unit sets the dB level of audio data having a frequency band of 20-500 Hz.

8. An apparatus for synchronizing audio with video, the apparatus comprising:
a storage unit for storing a music file and image data;
a decoder for decoding audio data of the music file when the music file is selected;
an audio output unit for processing the audio data decoded by the decoder so that the audio data is outputted;
a dB level setting unit for setting the dB level of the decoded audio data; and
a synchronizer for selecting the image data stored in the storage unit according to the dB level and allowing the image data to be outputted in synchronization with the audio data.

9. The apparatus according to claim 8, wherein the image data comprise an image identifier for indicating the image data selected according to the dB level of the audio data.

10. The apparatus according to claim 8, wherein the decoder accesses and decodes the audio data for each frame to convert the audio data into PCM (pulse code modulation) data.

11. The apparatus according to claim 10, wherein the audio output unit converts the PCM data into analog signals.

12. The apparatus according to claim 11, wherein the dB level setting unit sets the dB level by performing FFT (fast Fourier transform) on the PCM data.

13. The apparatus according to claim 12, wherein the dB level setting unit sets the dB level of audio data having a frequency band of 20-500 Hz.

14. A method for synchronizing audio with video, the method comprising:
accessing selected audio data for each frame to decode the audio data into PCM (pulse code modulation) data and outputting the same;
converting the PCM data into data in a frequency region;
selecting image data according to the dB level of the PCM data; and
displaying the image data in synchronization with the audio data.

15. The method according to claim 14, wherein the converting of the PCM data comprises performing FFT (fast Fourier transform) when the number of the PCM data is greater than a predetermined size as a result of counting the PCM data.

16. The method according to claim 14, wherein the image data is extracted from a music file containing the audio data.

17. The method according to claim 16, wherein the image data is inserted into a last frame of the audio data.

18. The method according to claim 16, wherein the selecting of the image data comprises selecting the image data according to the dB level of audio data having a frequency band of 20-500 Hz.

19. The method according to claim 16, wherein the image data comprise an image identifier for indicating the image data selected according to the dB level of the audio data.
